(19) United States
(12) Patent Application Publication
(10) Pub. No.: US 2011/0128115 A1
(43) Pub. Date: Jun. 2, 2011

(54) Non-Inductive Resistor and the Manufacturing Method Thereof

(76) Inventor: Chin-Chung Liao, Chutung Township (TW)

(21) Appl. No.: 12/834,047

(22) Filed: Jul. 12, 2010

(30) Foreign Application Priority Data
Dec. 2, 2009 (TW) 098141232

(51) Int. Cl. H01C 3/02; H01C 17/00

(52) U.S. Cl. 338/61; 29/610.1

(57) ABSTRACT

A non-inductive resistor and a method of manufacturing a non-inductive resistor are disclosed. The non-inductive resistor comprises a resistance rod, a conductive layer, a clockwise cut mark, and a counterclockwise cut mark. The resistance rod comprises a first end and a second end, and a cutting center is established between the first end and the second end. The conductive layer is used for covering the resistance rod between the first end and the second end. The clockwise cut mark is situated on the conductive layer between the first end and the cutting center. The counterclockwise cut mark is situated on the conductive layer between the second end and the cutting center, wherein the clockwise cut mark and counterclockwise cut mark are used for counteracting an inductance effect of the non-inductive resistor.

### BACKGROUND OF THE INVENTION

1. Field of the Invention

The present invention relates to a non-inductive resistor and its manufacturing method, and more particularly, to a type of non-inductive resistor which has clockwise and counterclockwise cut marks, and the manufacturing method of the non-inductive resistor.

2. Description of Related Art

The resistor is one of the basic components in electronic devices or on circuit boards. The main function of the resistor is to regulate current or voltage in the circuit. During the process of cutting or etching of the traditional resistor, and whether the process utilizes the diamond blade cutting or laser etching, a number of circular loops will be created on the electronic circuit; a current rotation effect will be created when the current passes through the conductive layer of the resistor. According to Flemming's right hand rule, an inductance effect is created at the center of the current rotation, and this inductance effect produces noise when the circuit is powered on or produces undesirable noise in the speaker of the audio system.

Generally speaking, the resistor produces voltage v(t) and current i(t), both of which vary with time. With the component's inductance value L, the equation can be expressed using differentiation as:

$$v ( t ) = L \frac{d i ( t )}{d t}$$

Therefore, a sinusoidal voltage is produced when a sinusoidal alternating current passes through this resistor. The voltage is directly proportional to the product between the current's amplitude (I_{P}) and the current's frequency (f). The relationship between the resistor's current and voltage can be expressed by the following equations:

$$i ( t ) = {I}_{P} sin ( 2 π f t )$$

$$\frac{d i ( t )}{d t} = 2 π f {I}_{p} cos ( 2 π f t )$$

$$v ( t ) = 2 π f {LI}_{p} cos ( 2 π f t )$$

Under these circumstances, the current and voltage through the resistor have a phase shift of 90 degrees, with the current lagging the voltage. As a result, noise will be produced.

Therefore, some methods in the prior art have been invented to produce non-inductive resistors. The manufacturing method for the non-inductive resistor of prior inventions comprises: non-inductive wire-wound; non-inductive cutting; print pattern; and laser etching. However, the prior invention has its technical limitations.

For example, the non-inductive wire-wound cannot be used where precision or high resistance is required. Because the non-inductive cutting method cannot cut the resistor for more than half cycle of rod, the material utilization rate of this method is only 20%˜30%; this low rate will result in too much waste material. The manufacturing limitation of the print pattern method is that it is inapplicable to the make of small sized products; another weakness is that each of the products needs to be modified and etched after the printing process of conductive layer to produce the required resistance and standard deviation. This is a problem when mass production and cost considerations.

The original process of laser etching is used to categorize the resistance of the materials. The materials with resistance closest to the finish resistance are then chosen and treated with radial etching, thereby obtaining a high precision resistance. However, if the materials' initial resistance substantially deviates from the resistance of the final product, the time needed for etching is drastically increased; as a result, this technology tends to cause difficulties during mass production.

Therefore, it is necessary to invent a new type of non-inductive resistor and a method of manufacture thereof to solve the problems experienced by prior technologies.

### SUMMARY OF THE INVENTION

The main object of the present invention is to provide a type of non-inductive resistor, wherein an inductance effect of the non-inductive resistor is counteracted by a clockwise cut mark and a counterclockwise cut mark.

The other object of the present invention is to provide a method of manufacturing the non-inductive resistor.

In order to achieve the above objectives, the non-inductive resistor of the present invention comprises: a resistance rod; a conductive layer; a clockwise cut mark; and a counterclockwise cut mark. The resistance rod comprises a first end and a second end, wherein a cutting center is established between the two ends. The conductive layer is used for covering the resistance rod between the first end and the second end. The clockwise cut mark is situated on the conductive layer between the first end and the cutting center. The counterclockwise cut mark is situated on the conductive layer between the second end and the cutting center. The clockwise cut mark and counterclockwise cut mark are used for counteracting an inductance effect of the non-inductive resistance.

The manufacturing method for the non-inductive resistor of the present invention comprises the following steps: providing a resistance rod and covering the resistance rod with a conductive layer, wherein the resistance rod consists of a first end and a second end; defining a cutting center of the resistance rod; cutting the conductive layer from the first end towards the cutting center in a clockwise direction to create a cut mark; cutting the conductive layer from the second end towards the cutting center in a counterclockwise direction to create a cut mark.

### BRIEF DESCRIPTION OF THE DRAWINGS

FIG. 1 is a diagram showing the resistance rod of the present invention.

FIG. 2 is a diagram showing the conductive layer covering the resistance rod of the present invention

FIG. 3 is a diagram showing the non-inductive resistor of the present invention

FIG. 4 is a flow chart of the manufacturing method of the non-inductive resistor for the present invention.

### DETAILED DESCRIPTION OF THE PREFERRED EMBODIMENT

The advantages and innovative features of the invention will become more apparent from the following preferred embodiments.

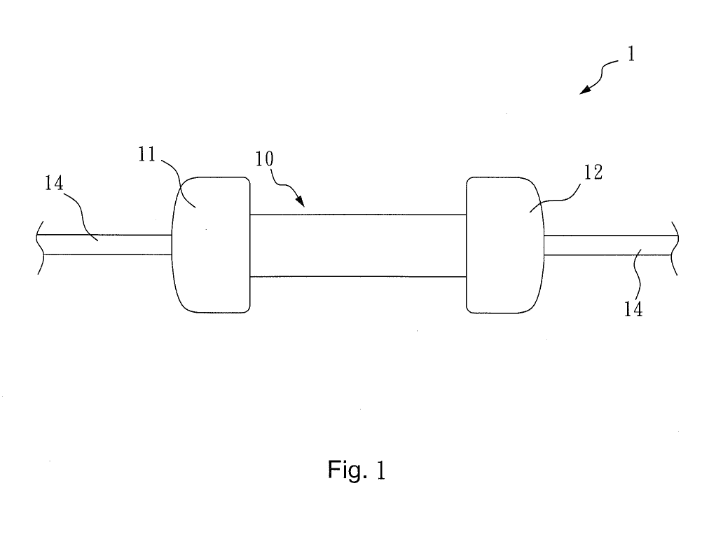

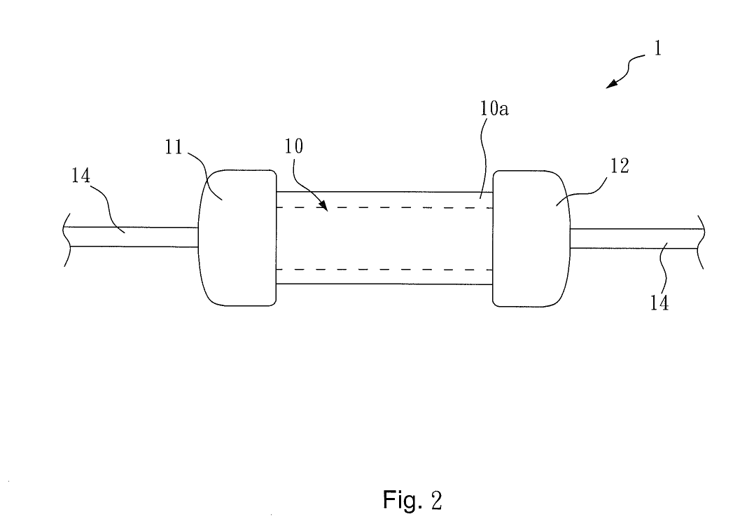

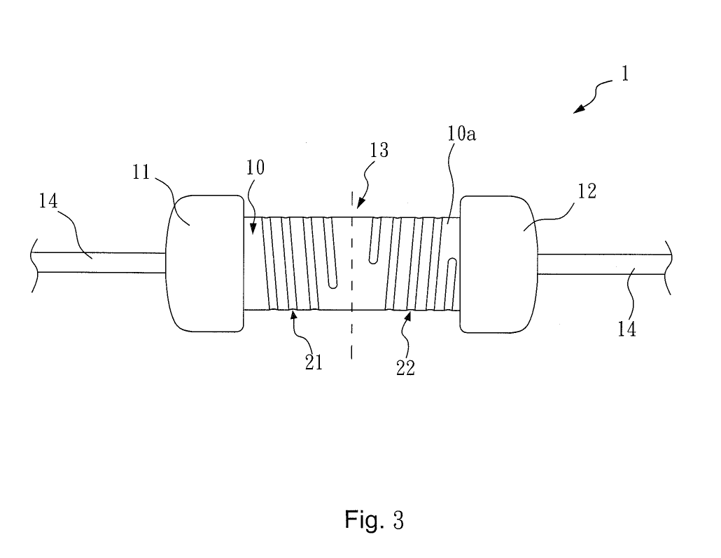

Please refer to FIG. 1, FIG. 2 and FIG. 3 of the non-inductive resistor of the present invention. FIG. 1 is a diagram of the rod. FIG. 2 is a diagram of the conductive layer covering the rod. FIG. 3 is a diagram of the non-inductive resistor.

The non-inductive resistor 1 of the present invention is a film type resistor. The non-inductive resistor 1 comprises: a resistance rod 10, a conductive layer 10a, a clockwise cut mark 21, and a counterclockwise cut mark 22. As shown in FIG. 1, the resistance rod 10 comprises a first end 11 and a second end 12. The first end 11 and the second end 12 are mounted on the end cap by gluing or welding, and are respectively connected to a metallic conducting wire 14, thus enabling the non-inductive resistor 1 to be electrically connected to an outer electrical component (not shown).

As shown in FIG. 2, the resistance rod 10 is covered with the conductive layer 10a to create resistance. Also shown in FIG. 3, the resistance rod 10 establishes a cutting center 13 which is substantially situated in the middle of the first end 11 and the second end 12.

The non-inductive resistor 1 further comprises a clockwise cut mark 21 and a counterclockwise cut mark 22. The clockwise cut mark 21 and the counterclockwise cut mark 22 are produced by a machine, but the present invention is not limited to this method.

The clockwise cut mark 21 begins at the first end 11 of the resistance rod 10. The conductive layer 10a is then cut towards the cutting center 13 in a clockwise direction; the clockwise cut mark 21 is thus created on the conductive layer 10a.

On the other hand, the counterclockwise cut mark 22 begins at the second end 12 of the rod 10. The conductive layer 10a is cut towards the cutting center 13 in a counterclockwise direction; the counterclockwise cut mark 22 is created thus on the conductive layer 10a. The clockwise cut mark 21 is situated between the first end 11 and the cutting center 13, and the counterclockwise cut mark 22 is situated between the second end 12 and the center cut mark 13. The number of loops on the clockwise cut mark 21 is equal to the number of loops on the counterclockwise cut mark 22.

By the above stated structure, the non-inductive resistor 1 produces 50% clockwise current and 50% counterclockwise current. According to Flemming's right hand rule, the inductances of the opposite currents will counteract each other. The number of loops of the clockwise cut mark 21 and the counterclockwise cut mark 22 are the same, and the inductances will counteract each other. Therefore, inductance will not be produced when current flows through the non-inductive resistor 1.

Take note that when a high precision non-inductive resistor 1 is to be manufactured, the mean of the standard deviation of the cutting center 13 can be calculated by the equation of mean of the standard deviation. This facilitates higher precision. The equation of the mean of the standard deviation can be expressed as:

$${σ}_{mean} = \frac{1}{R} sqrt ( {\int }_{{r}_{0}}^{{r}_{1}} r d r )$$

where σₘₑₐₙ is the mean of the standard deviation; r₁ is the maximum initial resistance of the material for the different non-inductive resistor 1; r₀ is the minimum initial resistance of the material for the different non-inductive resistor 1; and R is the resistance of the final non-inductive resistor 1.

If the resistance of the non-inductive resistor 1 is 10K (ohm), then the resistance at the cutting center 13 of the non-inductive resistor 1 should be 5 k (ohm). However, due to the materials and the manufacturing processes, the resistance of the different non-inductive resistors 1 may vary. Therefore, the present embodiment first tests by cutting the non-inductive resistor 1 with a material having the minimum initial resistance, and obtains a resistance, for example 5 k ohm. This value is then substituted into the mean of the standard deviation equation, and then the mean of the standard deviation can be calculated.

Next, it is determined whether the mean of the standard deviation exceeds the predicted set value. If that value is exceeded, then the position of the cutting center 13 is re-adjusted. Due to the materials and the manufacturing processes, different resistance rod 10 may have different resistances. Therefore, the present invention utilizes the equation of the maximum standard deviation for further assessment, wherein, the maximum standard deviation can be expressed as:

$${σ}_{max} = \frac{1}{R} sqrt ( {r}_{1}^{2} - {r}_{0}^{2} )$$

where σₘₐₓ is the maximum standard deviation; r₁ is the maximum initial resistance of the material for different non-inductive resistors 1; r₀ is the minimum initial resistance of the material for different non-inductive resistors 1; and R is the resistance of final non-inductive resistor 1.

When the initial resistances of the material for different resistance rod 10 are substituted into the equation, the maximum standard deviation can be determined from the different resistance rods 10. If the maximum standard deviation is too large, then it is necessary to reselect the resistance rods 10. Therefore, by using the above equation, the most suitable materials for the resistance rod 10 can be selected for the cutting process; for example, the maximum standard deviation must lie within +−1%. Therefore, it is possible to manufacture a high precision non-inductive resistor 1 by calculating the mean of the standard deviation and the maximum standard deviation.

The standard deviation of the resistance for the non-inductive resistor 1 can be estimated according to the cutting magnitude of the material of the non-inductive resistor 1 which is incurred from the material stage to the final product, and the standard deviation of the resistance can also be estimated through the initial material categorization requirements. The estimation is performed by dividing the categorization error by the cutting magnitude, and then multiplying by the standard deviation function, which yields the standard deviation of the resistance for the non-inductive resistor 1. For example, assume the following: The categorization error, i.e., the maximum standard deviation stated abovementioned, is 0.05; the cutting magnitude is 400, which is derived by dividing the resistance of the final product by the material's average initial resistance; the standard deviation is set to 10.

Therefore, the standard deviation of the resistance for the non-inductive resistor is 0.15%. As a result, it is confirmed that the resistance of non-inductive resistor 1 complies with the requirement. This will improve the yield rate of the non-inductive resistor and increase the customer's purchasing intentions.

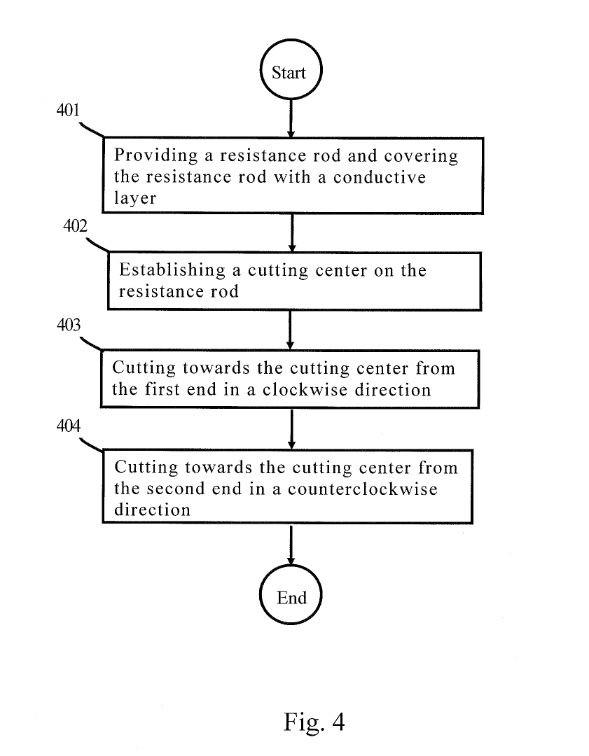

Please refer to FIG. 4, which is a flow diagram of the manufacturing procedure for the production of the non-inductive resistor of the present invention.

Take note that even though the manufacturing method of the non-inductive resistor has been explained with the example of the non-inductive resistor 1, the manufacturing method of the non-inductive resistor of the present invention is not restricted only to use with the non-inductive resistor 1. Any structure which is similar to the abovementioned structure of the non-inductive resistor can use the manufacturing method as disclosed in the present invention.

Firstly, proceed with step 401: providing a resistance rod and covering the resistance rod with a conductive layer.

As shown in FIG. 1 and FIG. 2, a resistance rod 10 is provided, and it is covered with the conductive layer 10a; this will create a resistance in the resistance rod 10. The manufacturing process of the conductive layer 10a which is used to cover the resistance rod 10 belongs to the film type resistor manufacturing process. This process is practiced widely; therefore, no further description will be provided.

Secondly, proceed with step 402: establishing a cutting center on the resistance rod.

As shown in FIG. 3, the process establishes a cutting center 13 on the resistance rod 10, wherein the position of the cutting center 13 is substantially in the middle between the first end 11 and the second end 12.

Take note that in order to produce the non-inductive resistor 1 with very high precision, the above stated step 401 and step 402 can utilize the calculation of the mean of the standard deviation and the maximum standard deviation to select the most suitable resistance rods 10 and calculate the exact location of the cutting center 13.

After establishing the position of the cutting center, proceed with step 403: cutting towards the cutting center from the first end in a clockwise direction.

Next, the process cuts the conductive layer 10a, by cutting from the first end 11 of the resistance rod 10 towards the cutting center 13 in a clockwise direction. As a result, the conductive layer 10a will have clockwise cut marks 21. The boundary of the clockwise cut marks 21 is located between the first end 11 and the cutting center 13.

Finally, proceed with step 404: cutting towards the cutting center from the second end in a counterclockwise direction.

Next, the process cuts the conductive layer 10a, by cutting from the second end 12 of the resistance rod 10 towards the cutting center 13 in a counterclockwise direction. As a result, the conductive layer 10a will have the counterclockwise cut marks 22. The boundary of the clockwise cut marks 22 is located between the second end 12 and the cutting center 13.

The clockwise cut mark 21 and the counterclockwise cut mark 22 are slanted at a specific angle, where the specific angle changes with the cut on the axial. The cut of the present invention is not restricted to any angles. Please take note that the clockwise cut mark 21 and the counterclockwise cut mark 22 do not have to be absolutely symmetrical to one another, but the number of cut loops on the conductive layer 10a should be the same in order to counteract the inductance effect produced on the non-inductive resistor 1.

Through the clockwise and counterclockwise cutting, the non-inductive resistor 1 is created, which will not produce any inductance effect on the conductive layer 10a. Take note that the method of manufacturing the non-inductive resistor 1 of the present invention is not limited to the procedures stated above. The above stated procedures can be altered as long as the purpose of the present invention can be accomplished.

Although the present invention has been explained in relation to its preferred embodiment, it is also of vital importance to acknowledge that many other possible modifications and variations can be made without departing from the spirit and scope of the invention as hereinafter claimed.

What is claimed is:

1. A type of non-inductive resistor comprises:
a resistance rod comprising a first end and a second end, and creating a cutting center between the first end and the second end;
a conductive layer covering the resistance rod between the first end and the second end;
a clockwise cut mark on the conductive layer which is located between the first end and the cutting center; and
a counterclockwise cut mark on the conductive layer which is located between the second end and the cutting center, wherein the clockwise cut mark and the counterclockwise cut mark are used for counteracting an inductance effect of the non-inductive resistor.

2. The non-inductive resistor as claimed in claim 1, wherein the position of the cutting center is substantially in the middle between the first end and the second end.

3. The non-inductive resistor as claimed in claim 2, wherein the position of the cutting center on the embodiment is adjusted according to the mean of the standard deviation.

4. The non-inductive resistor as claimed in claim 1, wherein the clockwise cut mark on the conductive layer is created by a clockwise cutting method.

5. The non-inductive resistor as claimed in claim 1, wherein the counterclockwise cut mark on the conductive layer is created by a counterclockwise cutting method

6. The non-inductive resistor as claimed in claim 1, wherein the number of cut loops of the clockwise cut mark and the counterclockwise cut mark are the same.

7. The non-inductive resistor as claimed in claim 1, wherein the material of the resistance rod is selected according to the maximum standard deviation.

8. A type of method for manufacturing a non-inductive resistor comprising the following steps:
providing a resistance rod, wherein the resistance rod comprises a first and second end;
covering the resistance rod with a conductive layer;
creating a cutting center;
cutting the conductive layer from the first end towards the cutting center in a clockwise direction; and
cutting the conductive layer from the second end towards the cutting center in a counterclockwise direction.

9. The non-inductive resistor as claimed in claim 8, wherein the steps for creating the cutting center further comprises:
setting the center cut position substantially in the middle between the first end and the second end.

10. The non-inductive resistor as claimed in claim 9 further comprises the following steps:
adjusting the position of the cutting center according to the mean of the standard deviation, which is calculated by a mean of standard deviation formula; the equation of the mean of the standard deviation is expressed as:
$${σ}_{mean} = \frac{1}{R} sqrt ( {\int }_{{r}_{0}}^{{r}_{1}} r d r )$$
where σₘₑₐₙ is the mean of the standard deviation; r₁ is the maximum initial resistance of a non-inductive resistor material; r₀ is the minimum initial resistance of a non-inductive resistor material; and R is the resistance of a final non-inductive resistor material.

11. The method for manufacturing a non-inductive resistor as claimed in claim 8, wherein the boundary of the clockwise cut mark is located between the first end and the cutting center.

12. The method for manufacturing a non-inductive resistor as claimed in claim 8, wherein the boundary of the counterclockwise cut mark is located between the second end and the cutting center.

13. The method for manufacturing a non-inductive resistor as claimed in claim 8, wherein the numbers of cut loops on the clockwise cut mark and the counterclockwise cut mark are the same.

14. The method for manufacturing a non-inductive resistor as claimed in claim 8 further comprises the following steps:
selecting the materials of resistance rod according to an equation of maximum standard deviation; the equation of the maximum standard deviation is
$${σ}_{max} = \frac{1}{R} sqrt ( {r}_{1}^{2} - {r}_{0}^{2} ) ;$$
where or σₘₐₓ is the maximum standard deviation; r₁ is the maximum initial resistance of a non-inductive resistor material; r₀ is the minimum initial resistance of a non-inductive resistor material; and R is the resistance of a final non-inductive resistor material.
